(19) United States
(12) Patent Application Publication
(10) Pub. No.: US 2026/0103905 A1
(43) Pub. Date: Apr. 16, 2026

(54) Internal Vibratory Device for Compacting a Casting Compound

(71) Applicant: Robert Bosch GmbH, Stuttgart (DE)

(72) Inventors: Andreas Dettling, Filderstadt (DE); Jan Schenk, Kusterdingen (DE); Johannes Rentschler, Dettenhausen (DE); Lukas Horrenberger, Rot Am See (DE); Thomas Litwin, Stuttgart (DE)

(21) Appl. No.: 19/358,995

(22) Filed: Oct. 15, 2025

(30) Foreign Application Priority Data
Oct. 16, 2024 (DE) 10 2024 210 009.9

(51) Int. Cl. E04G 21/08; B01F 31/00; B01F 35/32; B01F 101/28

(52) U.S. Cl. CPC E04G 21/08; B01F 31/70; B01F 35/32025; B01F 35/3204; B01F 2101/28

(57) ABSTRACT

An internal vibratory device for compacting a casting compound includes a vibratory unit having an electric motor, an electronic unit electromechanically coupled to the vibratory unit for controlling the electric motor via a hose connection, and a power supply unit for electrically supplying power to the electronic unit and the electric motor. The electric motor can be controlled by the electronic unit for a short time such that a critical operating state, in particular a low power state of the power supply, can be indicated via a change in its rotational speed.

This application claims priority under 35 U.S. C. § 119 to application no. DE 10 2024 210 009.9, filed on Oct. 16, 2024 in Germany, the disclosure of which is incorporated herein by reference in its entirety.

### BACKGROUND

The disclosure relates to an internal vibratory device for compacting a casting compound.

DE 103 54 002 A1 describes an internal vibratory device for compacting a flowable material with a vibratory unit, wherein a vibration generation device with an electric motor and an operating state detection device for detecting an operating state of the electric motor, for example a compacting operation of the vibratory device in concrete or a neutral operation in the air, is provided in the vibratory unit. The internal vibratory device further comprises a control device associated with the operating state detection device for controlling the rotational speed of the electric motor depending on the detected operating state.

DE 10 2018 118 555 A1 discloses an internal vibratory device, which comprises a carrying device having a portable support frame, wherein the support frame carries an energy store, at least one electric motor, and a coupling device for mechanically coupling a vibratory unit to be driven by the electric motor, and wherein the carrying device is configured as a shoulder bag or a backpack unit with at least one strap for carrying the carrying device over a user's shoulder.

It is the object of the disclosure to reliably indicate an operation state change to the operator of an internal vibratory device in an efficient manner.

### SUMMARY

The disclosure proceeds from an internal vibratory device having an electric motor an electronic unit electromechanically coupled to the vibratory unit for controlling the electric motor via a hose connection, and a power supply unit for electrically supplying power to the electronic unit and the electric motor. The electric motor integrated in the vibratory unit generates vibrations via an unbalanced element driven by it, by way of which the casting compound can be compacted by expelling any air bubbles. To solve the task, it is provided that the electric motor can be controlled by the electronic unit for a short time, such that a critical operating state, in particular a low power state of the power supply, can be indicated via a change in its rotational speed. A particular advantage is that the operator of the internal vibratory device can be provided with reliable feedback on operating state changes in a simple manner. As no further components are necessary for the internal vibratory device, additional costs can be saved in serial production. In addition, the display according to the disclosure is protected to the greatest possible extent from damage and is insensitive to any type of contamination. A critical operating state is meant to be understood as affecting the operation of the internal vibratory device. In addition to the energy supply unit having too little energy, this can also be the case, for example, if there is too much energy or if the electric motor, the electronic unit, and/or the hose connection are malfunctioning. Damage to the vibratory unit and/or the power supply unit detected by an acceleration sensor due to a strong impact, fall, or the like can also trigger a critical operating state of the internal vibratory device. The hose connection is designed in such a way that it is rigid enough to enable the vibratory unit to be guided precisely using the handle, yet flexible enough to ensure that the vibrations generated by the unbalanced element are not transmitted undamped to the handle, thereby protecting the operator.

In a further development of the disclosure, it is provided that the electronic unit can be electrically coupled without tools via a cable to the power supply unit. This offers the particular advantage of allowing easy replacement between the power supply unit and the electronic unit, so that the internal vibratory device can be used either for location-independent operation with a battery or rechargeable battery supply, or for preferably very long-term use with a mains supply.

Preferably, the electronic unit of the internal vibratory device is configured as a handle part for holding and guiding the vibratory unit via the hose connection by the operator and the power supply unit as a portable backpack unit with at least one removable interchangeable battery pack. On the one hand, this enables flexible use, which offers increased safety due to the elimination of a power cord, while on the other hand, the backpack unit with the option of accommodating a plurality of interchangeable battery packs allows for a long period of use. In this context, the power supply unit, in particular the backpack unit, is preferably configured to receive at least four interchangeable battery packs. As the electric motor is located directly in the vibratory unit, vibrations caused by a mechanical shaft for driving the unbalanced element provided in the vibratory unit by way of an electric motor arranged in a backpack unit can also be avoided, whereby, on the other hand, the vibrations generated by the electric motor provided in the vibratory unit to indicate the critical operating state can be better detected by the operator via the handle.

In order to enable the operator to recognize the critical operating condition as efficiently and clearly as possible, the electronic unit controls the electric motor, in particular when the supply voltage of the power supply unit falls below a voltage threshold value, with at least one short-term current or voltage pulse in such a way that the current speed of the electric motor changes by at least 10%, preferably by at least 30%. Alternatively or additionally, it may be provided that the electrical unit controls the electric motor with a current or voltage pattern consisting of a defined sequence of current or voltage pulses.

In a further development, it is provided that the hose connection is designed such that it mechanically transmits a control of the electric motor generated by the electronic unit to the handle part. This means that the operator can perceive the change in rotational speed of the electric motor on the handle without any additional aids. With a corresponding vibration intensity, an acoustic perception, for example in the form of a hum sound, in an environment of at least one meter around the handle part is also possible. Reinforcement of the acoustic and/or haptic indicator can further be achieved by a specific design of the handle part, for example by internal resonators on the housing or the like. The resonators are configured to match the frequency of resonance of the imbalance produced by the electric motor in the vibratory part.

The number, strength and/or duration of the current or voltage pulses are adjustable by the electronic unit. This makes it possible to highlight critical operating conditions more clearly in comparison to normal operation, depending on the application and the casting material to be compacted.

### BRIEF DESCRIPTION OF THE DRAWINGS

The disclosure is explained below with reference to FIGS. 1 through 3 by way of example, wherein identical reference numbers in the drawings indicate identical components having an identical function.

Shown are

FIG. 1: an internal vibratory device for compacting a casting compound comprising a vibratory unit, an electrical unit configured as a handle part, and a power supply unit configured as a backpack unit in a perspective view,

FIG. 2: a diagram of a time curve of a supply voltage of the internal vibratory device and a control of the vibratory unit according to the disclosure when falling below a threshold voltage value in a first exemplary embodiment, and

FIG. 3: a diagram of a time curve of the control of the vibratory unit according to the disclosure with a current or voltage pattern in a second exemplary embodiment.

### DETAILED DESCRIPTION

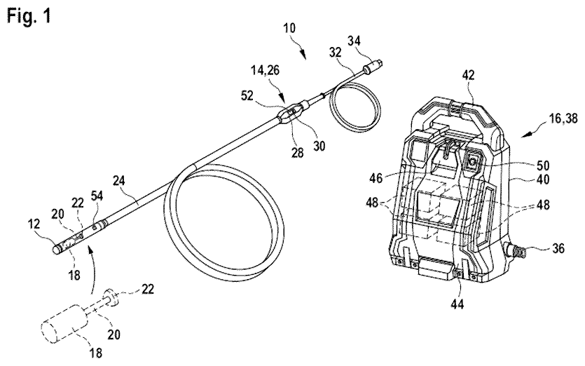

FIG. 1 shows an internal vibratory device 10 comprising a vibrator unit 12, an electronic unit 14, and a power supply unit 16. The vibratory unit 12 is configured as a cylindrical bottle, the interior of which is arranged with an electric motor 18 driving an imbalance element 22 via a motor shaft 20. The imbalance element 22 serves to generate vibrations of the vibratory unit 12 such that a casting compound, e.g. liquid concrete, in which the vibratory unit 12 is immersed is compressed by the expelling of any air bubbles. To this end, the vibratory unit 12 is coupled to the electronic unit 14 via a hose connection 24. The electronic unit 14 is configured as a handle part 26, the housing 28 of which houses an electronic unit (not shown) for controlling or controlling the electric motor 18 of the vibratory unit 12. Depending on the pressure travel of a main button 30 arranged on the housing 28 of the handle part 26, an operator can specify a desired rotational speed of the electric motor 18, preferably designed as an EC motor, and of the unbalance element 22 driven by it in order to influence the vibrations. For this purpose, the electronic unit 14 has a control unit or regulating unit and power electronics, wherein the control unit or regulating unit controls the power electronics configured as a power bridge via pulse width modulation (PWM) such that the power bridge applies trapezoidal or near sinusoidal commutation to the individual phases of the EC motor in a known manner. When the main button 30 is released, it automatically disengages due to spring force and the electric motor 18 comes to a standstill. To maintain the rotational speed of the electric motor 18, a locking of the main button 30 (not shown) can further be provided.

The hose connection 24 does not only have wiring for the controller or regulator of the electric motor 18 via the electronic unit 14, it is also used for mechanical coupling so that the operator can guide the vibratory unit 12 in the casting compound using the handle part 26. Thus, the hose connection 24 must be stiff enough to enable targeted guidance of the vibratory unit 12, while also being flexible enough to ensure that the vibrations generated by the imbalance element 22 are not transmitted undamped to the handle part 26 thereby protecting the operator.

The electronic unit 14 integrated in the handle part 26 can be electrically coupled to the power supply unit 16 without tools via a cable 32. To this end, the cable 32 comprises a plug 34 that can be connected to a mating plug (not shown) or a complementary designed socket of cable 36 of the power supply unit 16. In the exemplary embodiment shown, the power supply unit 16 is represented as a backpack unit 38 that can be carried on the operator's back, wherein the actual backpack frame with the corresponding carrying and/or fixation straps is not shown. The backpack unit 38 includes a housing 40 with a carrying handle 42 for ease of handling for the operator. In addition, a hinged lid 44 can be opened by way of a lever 46 and locked in the closed state. The lever 46 is also used for locking and unlocking the housing 40 on and from the support frame. A plurality of alternating battery packs 48 are releasably receivable in corresponding alternating packaging behind the lid 44. Preferably, up to four conventional interchangeable battery packs 48 for power tools can be accommodated in order to achieve as long a service life as possible. The power supply of the interchangeable battery packs 48 to the connected electronic unit 14 can be enabled by way of a start button 50.

The voltage class of a commercially available interchangeable battery pack 48 results from the connection (parallel or serial) of the individual energy storage cells (not shown) integrated in the interchangeable battery pack 48 and is usually a whole number multiple (>=1) of the voltage of the individual energy storage cells. An energy storage cell is typically designed as a galvanic cell which has a structure in which one cell pole is arranged at one end and a further cell pole comes to lie at an opposite end. In particular, the energy storage cell has a positive cell pole on one end and a negative cell pole on the opposite end. Preferably, the energy storage cells are designed as lithium-based button cells, e.g., Li-ion, Li-cell polymer, Li-metal, or the like, wherein the cell poles are arranged at the flat ends of the cylinder shape. However, the disclosure can also be applied to Ni—Cd, Ni—Mh cells or other suitable cell types. Common Li-ion energy storage cells typically have a cell voltage of 3.6 V. Deviating cell voltages are possible for pouch cells and/or cells with a different electrochemical composition. Although the disclosure does not depend on the type and design of the energy storage cells used, it can be applied to any interchangeable battery packs 48, which instead of round cells, use prismatic cells, pouch cells, or the like. However, interchangeable battery packs 48 with a voltage class of 18 V are common such that the internal vibratory device 10 can be used with two interchangeable battery packs 48 connected in series, which are connected in parallel, by way of example, with a supply voltage U of 36 V.

Without limitation of the disclosure, stationary or rollable power supply units 16 are also conceivable, which may also be equipped with one or more AC/DC converters for converting a mains voltage into the required supply voltage U instead of with interchangeable battery packs 48. This means that the cable connection 32, 36 provides a simple exchange option between the power supply unit 16 and the electronic unit 14, while the internal vibratory device 10 can be used either for location-independent operation with a battery or rechargeable battery supply, or for continuous operation via a mains or generator supply. The control and/or adjustment of operating parameters and/or the display of operating data of the internal vibratory device 10, such as a vibration level, a charging state of the connected power supply unit 16, or the like, is carried out via a human machine interface (HMI) 52 of the handle part 26 configured as a touch display or an LED display.

In order to indicate a critical operating state of the internal vibratory device 10 to the operator in a simple and reliable manner, the electric motor 18 of the vibratory unit 12 can be briefly controlled by the electronic unit 14 by changing its speed n. As already mentioned in the beginning, a critical operating state is to be understood to mean that the operation of the internal vibratory device 10 is impaired. This may be the case, for example, if the energy supply unit 16 has too little energy, but also if it has too much energy or if the electric motor 18, the electronic unit 14, and/or the hose connection 24 are malfunctioning. Likewise, damage of the vibratory unit 12 detected by way of an accelerometer 54 integrated in the vibratory unit 12 can trigger a critical operating state of the internal vibratory device 10 by way of a heavy impact, fall, or the like. A corresponding acceleration sensor 54 may also be provided in addition or alternatively in the handle part 14 and the power supply unit 16.

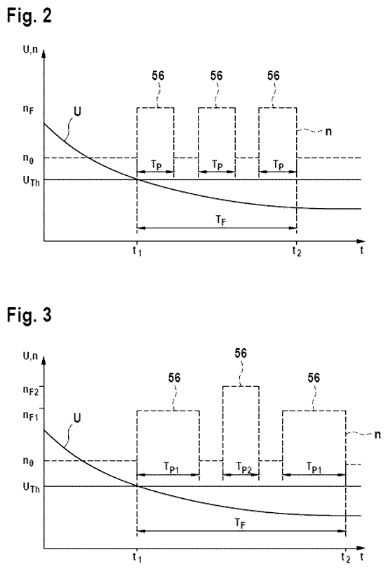

FIG. 2 shows a diagram of the curve of the supply voltage U provided by the power supply unit 16 over time t. It must be noted that the supply voltage U decreases exponentially, because, for example, the interchangeable battery packs 48 have discharged nearly completely after a certain period of operation. At a time t1, the supply voltage U drops below a defined voltage threshold value U_{Th}. In order to indicate this critical operating state to the operator as efficiently and safely as possible, the electronic unit 14 controls the electric motor 18 after time t1 within a defined time window T_{F} with a current or voltage pattern consisting of a sequence of short-term current or voltage pulses 56 in such a way that the current speed n0 of the electric motor 18 increases significantly, preferably by at least 10%, to a feedback speed n_{F}. For example, during the 4 s time window, the speed n can increase T_{F} from n₀=1,000 rpm to n_{F}>1,100 rpm within the three 1-second pulse times T_{P} of the current or voltage pulses 56. In order to achieve an even better distinction from the current speed n₀, it can be provided to increase the speed n by at least 30%. To ensure that the vibration pattern generated in this way in the vibration unit 12 can be perceived as clearly as possible by the operator on the handle 26, the hose connection 24 is designed in such a way that it mechanically transmits the control signals generated by the electronic unit 14 to the electric motor 18 to the handle 26. For example, the hose connection 24 may have a stiffening tendon or sheathing configured for a resonance frequency of the current or voltage pulses 56. A particular advantage is that the operator of the internal vibratory device 10 can be provided with reliable feedback on operating state changes in a simple manner. No further components are therefore necessary for the internal vibratory device 10, and additional costs can be saved in serial production. With a corresponding vibration intensity, an acoustic perception, for example in the form of a hum sound, in an environment of at least one meter around the handle part 26 is also possible. Reinforcement of the acoustic and/or haptic indicator can further be achieved by a specific design of the handle part 26, for example by internal resonators (not shown in detail) on the housing 30 or the like. The resonators are configured to match the frequency of resonance of the imbalance produced by the electric motor 18 in the vibratory part 12.

FIG. 3 shows a further exemplary embodiment for a possible current or voltage pattern in the event that the supply voltage value U at the time t1 drops below the defined voltage threshold value U_{Th}. In contrast to FIG. 2, the current or voltage pattern now consists of three current or voltage pulses 56 with two different pulse times T_{P1} (long), T_{P2} (short) and two different feedback speeds n_{F1}, n_{F2}. The different feedback speeds n_{F1}, n_{F2} themselves cause different vibration frequencies that are perceptible by the operator in the handle part 26 in connection with the pulse times T_{P1}, T_{P2} as a characteristic pattern for a given critical operating state. Thus, it is possible to assign different critical operating conditions to different current or voltage patterns in each case in order to more clearly differentiate them from normal operation at a typical speed n0 as a function of the application and the casting compound to be compacted. The current or voltage patterns can preferably be adjusted via the HMI 52 of the handle part 26 and assigned to the different critical operating states. Also, instead of the steep-slope current or voltage pulses 56, such with increasing or decreasing ramps or non-linear curves, may be selectable or adjustable. The current or voltage pulses 56 are thus preferably changeable in number, strength and/or duration by the electronic unit 14.

It should be finally pointed out that the embodiments shown are neither limited to the embodiments shown in FIGS. 1 to 3 nor to the stated values, in particular with regard to the durations T_{F}, T_{P}, T_{P1}, T_{P2}, the speeds n₀, n_{F}, n_{F1}, n_{F2} and the curve of the supply voltage U. In addition, the handle part 26 can also be designed as a D-shaped handle, as is common for larger drill hammers, or the like.

What is claimed is:

1. An internal vibratory device for compacting a casting compound, comprising:
a vibratory unit having an electric motor;
an electronic unit electromechanically coupled to the vibratory unit and configured to control the electric motor via a hose connection; and
a power supply unit configured to supply power to the electronic unit and the electric motor,
wherein the electric motor can be controlled by the electronic unit for a short time such that a low power state of the power supply can be indicated via a change in its rotational speed.

2. The internal vibratory device according to claim 1, wherein the electronic unit is configured to be electrically coupled to the power supply unit via a cable without tools.

3. The internal vibratory device according to claim 1, wherein the electronic unit is configured as a handle part for holding and guiding the vibratory unit via the hose connection by an operator and the power supply unit is configured as a backpack unit that can be carried by the operator, with at least one removable interchangeable battery pack.

4. The internal vibratory device according to claim 1, wherein the electronic unit is configured to control the electric motor when the supply voltage of the power supply unit falls below a voltage threshold value, with at least one short-term current or voltage pulse, such that the current speed of the electric motor changes by at least 10%.

5. The internal vibratory device according to claim 1, wherein the electronic unit is configured to control the electric motor when the supply voltage of the power supply unit falls below a voltage threshold value, with a current or voltage pattern consisting of a defined sequence of current or voltage pulses.

6. The internal vibratory device according to claim 3, wherein the hose connection is configured to mechanically transfer control of the electric motor generated by the electronic unit to the handle part.

7. The internal vibratory device according to claim 1, wherein the change in the rotational speed of the electric motor is acoustically detectable in an environment of at least one meter around the handle part.

8. The internal vibratory device according to claim 5, wherein the current or voltage pulses are adjustable in number, strength and/or duration by the electronic unit.

9. The internal vibratory device according to claim 3, wherein the backpack unit is configured to receive at least four interchangeable battery packs.

10. An internal vibratory device for compacting a casting compound, comprising:
a vibratory unit having an electric motor;
an electronic unit electromechanically coupled to the vibratory unit for controlling the electric motor via a hose connection; and
a power supply unit for electrically supplying power to the electronic unit and the electric motor,
wherein the electric motor can be controlled by the electronic unit for a short time such that a critical operating state can be indicated via a change in its rotational speed.

11. The internal vibratory device according to claim 10, wherein the electronic unit is configured to control the electric motor in the event of the critical operating state.

12. The internal vibratory device according to claim 1, wherein the electronic unit is configured to control the electric motor when the supply voltage of the power supply unit falls below a voltage threshold value, with at least one short-term current or voltage pulse, such that the current speed of the electric motor changes by at least 30%.

13. The internal vibratory device according to claim 1, wherein the electronic unit is configured to control the electric motor in the event of a critical operating state.

14. The internal vibratory device according to claim 1, wherein the power supply unit is configured to receive at least four interchangeable battery packs.
